(19) United States
(12) Patent Application Publication
(10) Pub. No.: US 2025/0303350 A1
(43) Pub. Date: Oct. 2, 2025

(54) SYSTEMS AND METHODS FOR THERMAL DESPORPTION OF ANAESTHETIC AGENTS

(71) Applicant: CLASS 1 INC., Cambridge (CA)

(72) Inventors: Damian Thorne, Cambridge (CA); Mina Mehrata, Cambridge (CA); Cesar Martinez, Cambridge (CA)

(21) Appl. No.: 19/131,690

(22) PCT Filed: Jan. 31, 2023
(86) PCT No.: PCT/CA2023/050134

§ 371 Date: May 21, 2025

Related U.S. Application Data
(60) Provisional application No. 63/305,556, filed on Feb. 1, 2022.

(51) Int. Cl. B01D 53/04; B01D 53/70; B01J 20/20; B01J 20/34

(52) U.S. Cl. CPC B01D 53/0462; B01D 53/0454; B01D 53/70; B01J 20/20; B01J 20/3416; B01D 2253/102; B01D 2257/206; B01D 2259/4009

(57) ABSTRACT

Methods and systems of collecting an anaesthetic agent from a collection vessel are described herein. The systems include a fluid storage tank and a collection vessel housing an adsorbent material for adsorbing the anaesthetic agent. The collection vessel is configured to receive the heated fluid from the fluid storage tank, the heated fluid having a temperature and a pressure sufficient to thermally desorb the anaesthetic agent from the adsorbent material. The system also includes a heat exchanger configured to receive an outlet stream from the collection vessel comprising the anaesthetic agent and cool the outlet stream to a temperature below a threshold temperature to produce a liquid stream comprising the anaesthetic agent. The system also includes an accumulator configured to receive the liquid stream and separate the liquid stream into a waste stream and a collection stream, the collection stream comprising the anaesthetic agent.

### FIELD

This disclosure relates generally to systems and methods for desorbing agents from a collection vessel, and in particular to systems and methods for thermally desorbing anaesthetic agents after they have been collected from exhaust gases such as but not limited to exhaust gas expelled by patients in operating rooms.

### BACKGROUND

Healthcare workers in a variety of settings can sometimes be exposed to anaesthetic gases expelled by patients during medical procedures. These gases are typically halogenated hydrocarbons such as but not limited to halothane, isoflurane, enflurane, desflurane, and sevoflurane.

There are many potential benefits to collecting these halogenated hydrocarbons and processing them to medical standards rather than releasing them to the atmosphere. For example, collecting these halogenated hydrocarbons may reduce their cost and reduce environmental pollution.

Currently, systems can be provided for recovering halogenated hydrocarbon from exhaust gases expelled by patients. These systems typically use an adsorbent material in a collection vessel to adsorb the halogenated hydrocarbons from an exhaust gas stream. When the adsorbent material is saturated with halogenated hydrocarbons, the collection vessel is typically removed from the system and processed, such as by a purging gas, to desorb the halogenated hydrocarbons from the adsorbent. These systems often use chemical purging agents that may degrade the adsorbent material within the collection vessel when exposed to the purge gas.

Accordingly, there is a need for new apparatus, systems and methods for desorbing anaesthetic agents from collection vessels.

### SUMMARY

In accordance with a broad aspect, a system for collecting an anaesthetic agent from a collection vessel is described herein. The system includes a fluid storage tank configured to provide an inlet stream comprising a heated fluid. The system also includes a collection vessel housing an adsorbent material, the anaesthetic agent being adsorbed to the adsorbent material. The collection vessel is configured to receive the heated fluid of the inlet stream. The heated fluid has a temperature and a pressure sufficient to thermally desorb the anaesthetic agent from the adsorbent material. The collection vessel is also configured to provide an outlet stream comprising the anaesthetic agent. The system also includes a heat exchanger configured to receive the outlet stream from the collection vessel and cool the outlet stream to a temperature below a threshold temperature to produce a liquid stream comprising the anaesthetic agent. The system also includes an accumulator configured to receive the liquid stream and separate the liquid stream into a waste stream and a collection stream by settling. The collection stream includes the anaesthetic agent.

In at least one embodiment, the temperature of the heated fluid is in a range of about 90° C. to about 110° C., or about 100° C.

In at least one embodiment, the pressure of the heated fluid is about 15 PSI.

In at least one embodiment, the heated fluid is steam.

In at least one embodiment, the collection vessel has a temperature in a range of about 90° C. to about 110° C.

In at least one embodiment, the adsorbent material is activated carbon.

In at least one embodiment, the anaesthetic agent is a halogenated hydrocarbon.

In at least one embodiment, the heat exchanger cools the outlet stream to a temperature of about 5° C. to produce the liquid stream.

In at least one embodiment, the system also includes a control system configured to monitor the temperature of the collection vessel.

In at least one embodiment, the control system is configured to, in response to the temperature of the collection vessel falling below a threshold pressure, increase a flow rate of the heated fluid into the collection vessel.

In at least one embodiment, the control system is configured to, in response to the temperature of the collection vessel rising above a threshold pressure, decrease a flow rate of the heated fluid into the collection vessel.

In at least one embodiment, the control system is further configured to monitor a temperature of the liquid stream downstream from the heat exchanger.

In at least one embodiment, the control system is further configured to, in response to the temperature of the liquid stream rising above a critical liquid temperature, control the heat exchanger to lower the temperature of the liquid stream.

In at least one embodiment, the control system is further configured to monitor a presence of the anaesthetic agent in the accumulator.

In at least one embodiment, the control system is further configured to, in response to a volume of the anaesthetic agent in the accumulator being greater than a threshold volume, increase a flow rate of the anaesthetic agent out of the accumulator.

In accordance with another broad aspect, a method of collecting an anaesthetic agent from a collection vessel is described herein. The method includes receiving a heated fluid at the collection vessel housing an adsorbent material. The anaesthetic agent is adsorbed to the adsorbent material and the heated fluid has a temperature and a pressure sufficient to thermally desorb the anaesthetic agent from the adsorbent material. The method also includes providing an outlet stream to a heat exchanger from the collection vessel, the outlet stream comprising a vapor comprising the anaesthetic agent. The method also includes cooling the outlet stream by the heat exchanger to a temperature below a threshold temperature to produce a liquid stream comprising the anaesthetic agent. The method also includes separating the liquid stream into a waste stream and a collection stream by settling at an accumulator, the collection stream comprising the anaesthetic agent.

In at least one embodiment, the method also includes monitoring the temperature of the collection vessel by a control system.

In at least one embodiment, the method also includes, in response to the temperature of the collection vessel falling below a threshold pressure, increasing a flow rate of the heated fluid into the collection vessel.

In at least one embodiment, the method also includes, in response to the temperature of the collection vessel rising above a threshold pressure, decreasing a flow rate of the heated fluid into the collection vessel.

In at least one embodiment, the method also includes monitoring a temperature of the liquid stream downstream from the heat exchanger by the control system.

In at least one embodiment, the method also includes, in response to the temperature of the liquid stream rising above a critical liquid temperature, controlling the heat exchanger to lower the temperature of the liquid stream.

In at least one embodiment, the method also includes monitoring a presence of the anaesthetic agent in the accumulator.

In at least one embodiment, the method also includes, in response to a volume of the anaesthetic agent in the accumulator being greater than a threshold volume, increasing a flow rate of the anaesthetic agent out of the accumulator.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a schematic diagram of a system for collecting anaesthetic gases, according to at least one embodiment described herein.

FIG. 2 is a schematic diagram of a central collection system of the system for collecting anaesthetic gases of FIG. 1.

FIG. 3 is a schematic diagram of a system for collecting an anaesthetic agent from a collection vessel, according to at least one embodiment described herein.

FIG. 4 is a block diagram of a method of collecting an anaesthetic agent from a collection vessel, according to at least one embodiment described herein.

Further aspects and features of the example embodiments described herein will appear from the following description taken together with the accompanying drawings.

### DESCRIPTION OF EXAMPLE EMBODIMENTS

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive-or. That is, “X and/or Y” is intended to mean X, Y or X and Y, for example. As a further example, “X, Y, and/or Z” is intended to mean X or Y or Z or any combination thereof. Also, the expression of A, B and C means various combinations including A; B; C; A and B; A and C; B and C; or A, B and C.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Recently, there has been a growing interest in developing new systems and methods of collecting anaesthetic gases and specifically, of desorbing anaesthetic agents after they've been collected in a collection vessel from an exhaust gas.

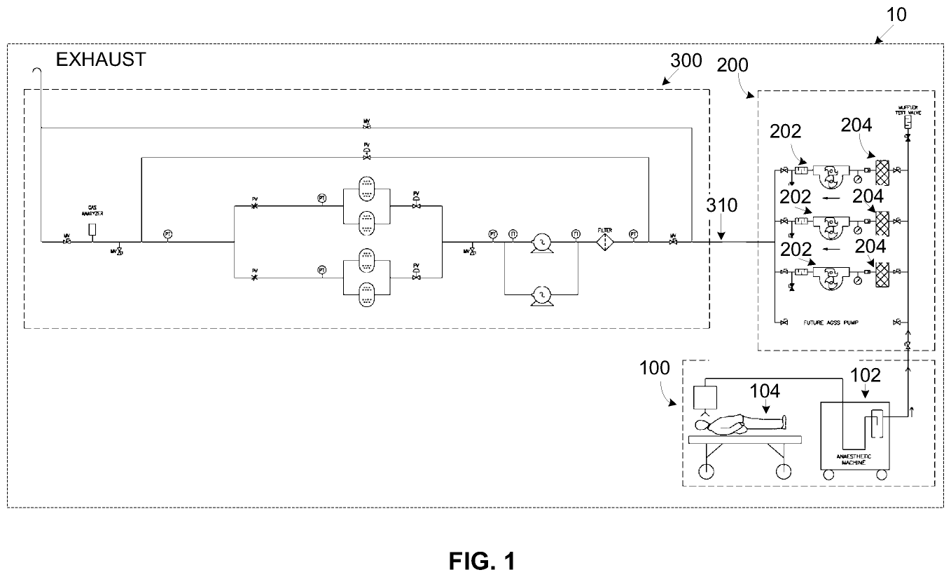

Referring to FIG. 1, illustrated therein is a system 10 for collecting anaesthetic agents from exhaust gases. System 10 includes an advanced gas scavenging system (AGSS) 200 fluidly coupled to one or more sources of the exhaust gas 100, according to at least one embodiment.

In FIG. 1, the one or more sources of the exhaust gas 100 are represented by the collection of units/spaces within the dashed box identified with the reference number 100. In at least one embodiment, the one or more sources of exhaust gas 100 may be from one or more operating rooms in a healthcare facility. For example, in at least one embodiment such as the embodiment shown in FIG. 1, the one or more operating rooms 100 may have an anaesthetic machine 102 connected to one or more patients 104 for administering one or more anaesthetic agents (such as but not limited to halogenated drugs, nitrous oxide, etc.) during or in association with a medical procedure. In some cases, the anaesthetic machine 102 may also collect exhaust gases from the patient 104 and direct those exhaust gases to the collection system 300, for example, through an exhaust port in the operating room 100. In some embodiments, a conservation valve (not shown) may be located between the anaesthetic machine 102 and the exhaust port.

In some embodiments, the exhaust gases may come from other sources, such as but not limited to an outpatient clinic, a surgery clinic, a doctor's office, an oral surgery clinic, a veterinary clinic, or other types of healthcare facilities.

AGSS 200 is represented in FIG. 1 by the collection of units within the dashed box identified with the reference number 200. As shown in FIG. 1, AGSS 200, also sometimes referred to as a Waste Anaesthetic Gas Disposal (“WAGD”), may be connected to the one or more sources of exhaust gas 100 and to the collection system 300. As shown in FIG. 1, the AGSS 200 may be located between the one or more sources of exhaust gas 100 and the collection system 300.

Generally, the AGSS 200 draws exhaust gases from the one or more sources of exhaust gas 100 and directs these exhaust gases to the collection system 300. For example, the AGSS 200 may include one or more power source(s) 202, such as but not limited to a vacuum pump, or a blower, or a fan or the like, connected to the exhaust port(s) of the one or more sources of exhaust gas 100 through piping, ducting or other mediums for transporting liquids or gases (collectively referred to as “piping” herein). In one or more embodiments, the power source(s) 200 may be connected to an inlet port of the collection system 300 through piping. In the embodiment shown in FIG. 1, the AGSS 200 includes, but is not limited to, three power sources 202 operating in series.

AGSS 200 may also include one or more filters 204, such as but not limited to a high-efficiency particulate air (HEPA) filter or an ultra-low particulate air (ULPA) filter, or the like. Filter 204 may provide for removing impurities such as but not limited to dust, dirt, etc. present in the exhaust gas. Generally, filters 204 are positioned between the power source 202 and the exhaust port of the one or more sources of gas 100 to remove any impurities from the exhaust gas before the exhaust gas enters the power source 202.

In the embodiment shown in FIG. 1, AGSS 200 includes three filters 204, positioned immediately before one of the three power sources 202 to remove any impurities from the exhaust gas before the exhaust gas enters the power source 202.

In some embodiments, the AGSS 200 may include two or more power sources 202 connected in parallel. Having an additional power source 202 may provide a back-up in case one power source 202 stops operating (e.g. breaks down or needs maintenance), which may improve system redundancy. Additional power sources 202 may also increase the suction, for example, when the AGSS 200 is connected to larger systems (e.g. a greater number of operating rooms). Furthermore, in some embodiments there may be more than one AGSS 200, which may be connected in parallel, for example, to provide redundancy.

System 10 also includes a collection system 300 for collecting anesthetic agents, such as but not limited to halogenated drugs, for later reclaiming, from the one or more sources of exhaust gas 100, according to at least one embodiment. Collection system 300 may be installed in a healthcare facility such as a hospital and may be centrally located such that it is in fluid communication with one or more sources of exhaust gas 100.

In at least one embodiment, the collection system 300 may be remotely located relative to the one or more sources of exhaust gas 100. For example, collection system 300 may be located within the hospital at a location that is both central and remote relative to one or more sources of exhaust gas 100 while remaining in fluid communication with the one or more sources of exhaust gas 100 via piping.

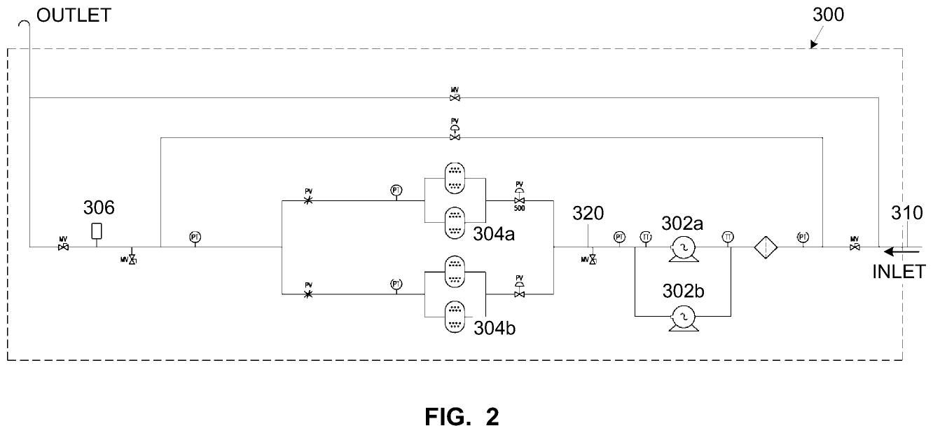

Collection system 300, shown in greater detail in FIG. 2, includes an inlet stream 310, at least one compressor 302, at least one collection vessel 304 and a gas analyzer 306. In the embodiment shown in FIG. 2, the collection system 300 includes two sets of collection vessels, a first set 304a and a second set 304b. In the embodiment shown in FIG. 2, each set of collection vessels is shown having two collection vessels operating in parallel. It should be understood that each set of collection vessels may have more than two collection vessels operating in parallel

During normal operation, each of the collection vessels of first set 304a and a second set 304b are configured to remove anaesthetic agent(s) from the compressed exhaust gas stream 320 exiting the compressor(s) 302 (e.g., compressor 302a and/or compressor 302b). Compressed exhaust gas stream 320 may pass through the first set or second set of collection vessels 304a and 304b, respectively, even when they are saturated with anaesthetic agent and cannot remove anaesthetic agents from the exhaust gas flow. Each of the collection vessels of each of first set 304a and second set 304b is operated in parallel with the other collection vessels in the respective set, so, if one of the collection vessels is full, the system is configured for the compressed exhaust gas stream 320 to flow into another collection vessel, for example of first set 304a, while the full collection vessel is either replaced with a new tank with fresh adsorbent or processed to remove the anaesthetic, such as but not limited to by the desorbing methods described below.

In at least one embodiment, as compressed exhaust gas stream 320 passes through each of the first set and the second set of collection vessels, 304a and 304b respectively, the compressed exhaust gas stream 320 passes through a bed of adsorbent material (e.g. media) until the adsorbent material is saturated to the extent that breakthrough of the anaesthetic agents is determined (e.g. halogenated hydrocarbons are detected downstream of the first set 304a or second set 304b of collection vessels, such as but not limited to by the analyzer 306.

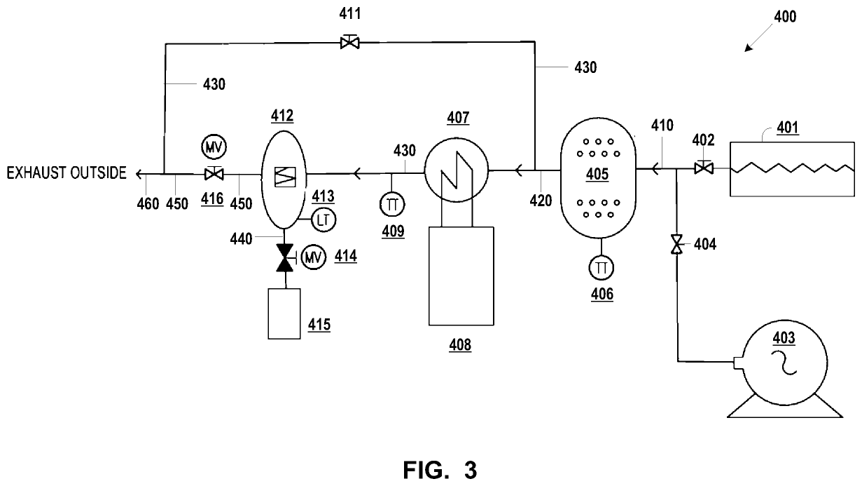

Referring now to FIG. 3, a system 400 for desorbing an anaesthetic agent from a collection vessel is shown therein. System 400 is configured to perform a thermal desorption process to desorb one or more anaesthetic agents from a collection vessel 405. It should be understood that in FIG. 3, collection vessel 405 represents one of the collection vessels of the first set 304a and/or second set 304b of collection vessels of FIG. 2.

As noted above, collection vessel 405 is charged with an adsorbent that adsorbs one or more anesthetics from a gas stream, such as but not limited to compressed gas stream 320 exiting AGSS 200, intending to leave the stream 420 discharged from the collection vessel 405 free to be discharged to atmosphere substantially free of inhalation anesthetics.

In some embodiments, collection vessel 405 may be filled with more than one anesthetic.

System 400 may be configured to process a single collection vessel 405 at a time or multiple collection vessels 405 in series or in parallel.

System 400 includes a fluid source 401 fluidly coupled to the collection vessel 405 by, for example, piping. In the embodiment shown in FIG. 3, a control valve 402 is present between fluid source 401 and collection vessel 405. Control valve 402 can be used to control a flow of fluid from fluid source 401 to collection vessel 405.

The fluid from the fluid source 401 is used to thermally desorb one or more anaesthetic agents from collection vessel 405. In this manner, the fluid from fluid source 401 may act as a purge gas that both heats the adsorbent to release or desorb the anaesthetic agent(s) therefrom and carry the released anaesthetic agent out of collection vessel 405. In at least one embodiment, the fluid is an inert fluid, such as but not limited to water or steam. In at least one embodiment, fluid source 401 is a steam generator and is configured to provide steam to collection vessel 405, the steam having a temperature of about 100° C.

In order to heat the fluid of fluid source 401 to the desired temperature, the fluid source 401 may include but is not limited to including a conventional oven having heating coils surrounded by insulating material or a similar heating element.

The fluid of fluid source 401 has a pressure of about 15 PSI.

In the embodiment shown in FIG. 3, system 400 optionally includes a blower 403 coupled to the piping between fluid source 401 and collection vessel 405. Blower 403 may be used to clean the collection vessel 405. For example, in some instances it may be desirable to remove condensate from the desorbant within collection vessel 405. In some instances, it may be desirable to dry the adsorbent (i.e., remove water from inside collection vessel 405). In these cases, as well as other cases, blower 403 is configured to blow air into the inlet stream 410 and subsequently into collection vessel 405.

A second control valve 404 may be present between blower 403 and collection vessel 405 to control the flow of air between blower 403 and collection vessel 405. Typically, control valve 402 closes and fluid flow from fluid source 401 stops while blower 403 is operating to clean and/or dry collection vessel 405.

As described above, collection vessel 405 includes a bed of adsorbent material that is used to extract the anaesthetic agent. For example, the adsorbent bed may include but is not limited to including activated carbon.

During the activated carbon adsorption process, the anaesthetic agent(s) in the contaminated air reacts with the activated carbon and sticks to the outer surface of the activated carbon, effectively removing these anaesthetic agent(s) from the air. During the desorption process, the fluid passes through the collection vessel 405, increasing the temperature therein to provide for the anaesthetic agent(s) to desorb from the activated carbon.

It is appreciated that with different types of anaesthetic agent(s), such as but not limited to different types of halogenated hydrocarbons, different temperature ranges and/or different parameters of the fluid within the collection vessel 405 may be necessary to desorb the anaesthetic agent(s).

It is also appreciated that temperature and pressure both affect the amount of time required to desorb the anaesthetic agent(s) from the adsorbent material. Increasing the temperature and/or decreasing the pressure would generally reduce an amount of time required for desorption, while decreasing the temperature and/or increasing the pressure would generally increase the amount of time required for desorption.

In some cases, it may be desirable to desorb the anaesthetic agent(s) from the adsorbent material under a partial vacuum since the reduced pressure would reduce the temperature required to desorb the anaesthetic agent.

In at least one embodiment, the temperature of collection vessel 405 may be monitored by a temperature sensor 406 and a control system (not shown). Temperature sensor 406 provides an indication of the temperature within collection vessel 405. When the temperature of collection vessel 405 approaches or exceeds a critical temperature, the critical temperature generally equaling the temperature of the fluid in the inlet stream 410, it can be determined that the adsorbents are at a temperature nearing that of the temperature of the fluid in the inlet stream 410 and that most of the anaesthetic agent(s) in the collection vessel 405 are being desorbed from the adsorbent. For example, the critical temperature may be in a range of about 90° C. s to about 110° C., for be about 100° C. In this case, the control system can control valve 402 to maintain the current flow rate of the fluid of inlet stream 410 and therefore the current temperature within collection vessel 405. In at least one embodiment, the control system may fully automate the system 400.

In at least one embodiment, if the temperature sensor 406 reports a temperature of the collection vessel 406 that falls below the critical temperature, the control system can be configured to control valve 402 to increase the flow rate of fluid into collection vessel 405, thereby increasing the temperature of collection vessel 405. The temperature of collection vessel 405 falling below the critical temperature may be undesirable as it may lead to the anaesthetic agent(s) not being desorbed from the adsorbent within collection vessel 405.

In at least one embodiment, if the temperature sensor 406 reports a temperature of the collection vessel that exceeds the critical temperature, the control system can be configured to control valve 402 to reduce the flow rate of fluid into collection vessel 405, thereby reducing the temperature of collection vessel 405. In some cases, increasing the temperature of collection vessel 405 above the critical temperature may be undesirable as it may lead to degradation of the adsorbent within collection vessel 405.

In at least one embodiment, after removing the anaesthetic agent(s) from the collection vessel, system 400 may be used to collect the anaesthetic agent(s) from an exit stream 420 from collection vessel 405 using downstream processing units.

In some cases, it may be desirable to direct at least a portion of exit stream 420 around the downstream processing units (i.e. the processing units downstream of collection vessel 405 responsible for collecting the anaesthetic agent(s) from the fluid of fluid source 401). To accomplish this, system 400 may include an optional bypass stream 430 and a valve 411 for controlling the flow of fluid from exit stream 420 into bypass stream 430.

Although shown as bypassing all of the downstream processing units (e.g. heat exchanger 407, accumulator 412, etc.) and being configured to direct fluid therein directly to environment via environment stream 460, bypass stream 430 may be configured to redirect at least a portion of outlet stream 420 around any one or more of the downstream processing units.

As shown in FIG. 3, the first downstream processing unit of system 400 is a heat exchanger 407. Heat exchanger 407 is downstream of collection vessel 405 and receives at least a portion of the fluid of outlet stream 420 from collection vessel 405.

Heat exchanger 407 reduces the temperature of the fluid of outlet stream 420. The fluid of outlet stream 420 comprises the anaesthetic agent(s) from collection vessel 405, such as but not limited to halogenated hydrocarbons, after the anaesthetic agent(s) has been desorbed from the adsorbent within collection vessel 405. Heat exchanger 407 thereby condenses the fluid of outlet stream 420 to a liquid phase stream 430 that exits the heat exchanger 407. It should be understood that a majority of liquid phase stream 430 is a liquid, however, a portion of liquid phase stream 430 may remain in a gaseous phase.

In at least one embodiment, the heat exchanger 407 comprises a chiller 408. Chiller 408 generally removes heat from a liquid coolant via a vapor-compression, adsorption refrigeration, or absorption refrigeration cycle. This liquid can then be circulated through heat exchanger 407 to cool outlet stream 420.

In at least one embodiment, chiller 408 has a temperature of a range between 0° C. to 5° C. to provide for cooling outlet stream 420.

Generally, heat exchanger 407 provides for there to be no further significant anaesthetic agent(s) present in the vapor phase in liquid stream 430 outlet from the heat exchanger 407. In a manner similar to that which was noted above, a temperature sensor 409 may be included in liquid stream 430 to measure the temperature of liquid stream 430. Temperature sensor 409 provides an indication of the temperature of the liquid stream 430 to the control system. When the temperature of liquid stream 430 approaches or is below a critical liquid temperature, it can be determined that the anaesthetic agent(s) is almost entirely in the liquid phase. For example, in at least one embodiment, the critical temperature of liquid stream 430 is about 5° C., or about 10° C.

In at least one embodiment, if the temperature sensor 409 reports a temperature of the liquid stream 430 downstream from heat exchanger 407 that is greater than the critical liquid temperature, the control system can be configured to control chiller 408 to reduce the temperature of the heat exchanger 407, thereby decreasing the temperature of the liquid stream 430. The temperature of the liquid stream 430 rising above the critical liquid temperature may be undesirable as it may lead to the anaesthetic agent(s) remaining in the vapor phase and not being collected into the collection stream 440 at accumulator 412. If the anaesthetic agent(s) remains in the vapor phase and is not collected into the collection stream 440 at accumulator 412, the anaesthetic agent(s) may be discharged to the environment in waste stream 450, which is undesirable. In at least one embodiment, if temperature sensor 409 reports a temperature reports a temperature of the liquid stream 430 downstream from heat exchanger 407 that is greater than the critical liquid temperature (e.g. greater than about 5° C. or greater than about 10° C.), the control system may close a heat exchanger input valve (not shown; positioned upstream of heat exchanger 408 and downstream of collection vessel 405) to prevent any anesthetic agent in the vapor phase from leaving the system 400.

In at least one embodiment, if the temperature sensor 409 reports a temperature of the liquid stream 430 downstream from heat exchanger 407 that is less than the critical liquid temperature, the control system can be configured to control chiller 408 to increase the temperature of the heat exchanger 407, thereby increasing the temperature of the liquid stream 430.

Accumulator 412 is positioned downstream of the heat exchanger 407 to separate out the anaesthetic agent(s) from the remaining liquid present in the liquid stream 430. Liquid stream 430 typically includes the anaesthetic agent(s) and water. The anaesthetic agent(s) can typically be separated from the remaining water by settling. For instance, in at least one embodiment, water has a density of about 1 kg/L and the anaesthetic agent(s) has a density of about 1.5 kg/L. In this example, the anaesthetic agent(s) settles to the bottom of the accumulator 412 and can be collected, for example, in collection stream 440 from accumulator 412.

Collection stream 440 from accumulator 412 can be controlled, for example, by control valve 414. In one example, accumulator 412 includes a sensor 413 that measures the presence of the anaesthetic agent(s) in accumulator 412. Sensor 413 can report the presence of the anaesthetic agent(s) in the accumulator to the control system which can control the operation of control valve 414, which controls the flow of the anaesthetic agent(s) into the collection units 415 (e.g. bottles).

In at least one embodiment, clean water (e.g. in an amount of about 5 vol % of the anaesthetic agent(s) can be added to the collection units 415, together with the anaesthetic agent(s) to prevent degradation of the anaesthetic agent(s) until further processing is required.

The remaining liquid in accumulator 412 can be withdrawn into waste stream 450. Control valve 416 may be used to control the flow of liquid from accumulator 412 through waste stream 450.

In at least one embodiment, the bypass stream 430 and waste stream 450 can be combined to form the exhaust stream 460 that, for example, is exhaust to environment. In at least one embodiment, exhaust stream 460 contains primarily water, or only water.

In at least one embodiment, system 400 may also be used to regenerate the collection vessel after removal of the anaesthetic agent(s). For example, system 400 may be used to regenerate an adsorbent bed of the collection vessel 405 after desorbing the anaesthetic agent(s) from the adsorbent bed. In at least one embodiment, adsorbent bed of the collection vessel 405 may also be regenerated by drying (e.g., without the addition of steam from steam generator 401.

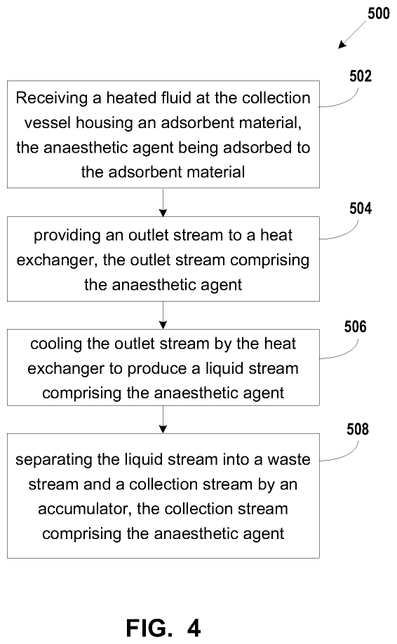

FIG. 4 shows a method 500 to collect an anaesthetic agent from a collection vessel, according to at least one embodiment described herein.

At a first step 502, a heated fluid is received at the collection vessel such as collection vessel 405. As described above, collection vessel 405 houses an adsorbent material and the anaesthetic agent is adsorbed to the adsorbent material. The heated fluid has a temperature and a pressure sufficient to thermally desorb the anaesthetic agent from the adsorbent material.

At a second step 504, the collection vessel 405 provides an outlet stream 420 to a heat exchanger 407. The outlet stream 420 comprises a vapor comprising the anaesthetic agent.

At a third step 506, outlet stream 420 is cooled by heat exchanger 407 to a temperature below a threshold temperature to produce a liquid stream 430 comprising the anaesthetic agent.

At a fourth step 508, liquid stream 430 is separated into a waste stream 450 and a collection stream 440 by settling at an accumulator 412. Collection stream 440 comprises the anaesthetic agent.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A system for collecting an anaesthetic agent from a collection vessel, the system comprising:
a fluid storage tank configured to provide an inlet stream comprising a heated fluid;
a collection vessel housing an adsorbent material, the anaesthetic agent being adsorbed to the adsorbent material, the collection vessel being configured to:
receive the heated fluid of the inlet stream, the heated fluid having a temperature and a pressure sufficient to thermally desorb the anaesthetic agent from the adsorbent material; and
provide an outlet stream comprising the anaesthetic agent;
a heat exchanger configured to receive the outlet stream from the collection vessel and cool the outlet stream to a temperature below a threshold temperature to produce a liquid stream comprising the anaesthetic agent; and
an accumulator configured to receive the liquid stream and separate the liquid stream into a waste stream and a collection stream by settling, the collection stream comprising the anaesthetic agent.

2. The system of claim 1, wherein the temperature of the heated fluid is in a range of about 90° C. to about 110° C.

3. The system of claim 1 or claim 2, wherein the pressure of the heated fluid is about 101 kPa.

4. The system of any one of claims 1 to 3, wherein the heated fluid is steam.

5. The system of any one of claims 1 to 4, wherein the collection vessel has a temperature in a range of about 90° C. to about 110° C.

6. The system of any one of claims 1 to 5, wherein the adsorbent material is activated carbon.

7. The system of any one of claims 1 to 6, wherein the anaesthetic agent is an halogenated hydrocarbon.

8. The system of any one of claims 1 to 7, wherein the heat exchanger cools the outlet stream to a temperature of about 5° C. to produce the liquid stream.

9. The system of any one of claims 1 to 8 further comprising a control system configured to monitor the temperature of the collection vessel.

10. The system of claim 9, wherein the control system is configured to, in response to the temperature of the collection vessel falling below a threshold pressure, increase a flow rate of the heated fluid into the collection vessel.

11. The system of claim 9, wherein the control system is configured to, in response to the temperature of the collection vessel rising above a threshold pressure, decrease a flow rate of the heated fluid into the collection vessel.

12. The system of any one of claims 9 to 11, wherein the control system is further configured to monitor a temperature of the liquid stream downstream from the heat exchanger.

13. The system of claim 12, wherein the control system is further configured to, in response to the temperature of the liquid stream rising above a critical liquid temperature, control the heat exchanger to lower the temperature of the liquid stream.

14. The system of any one of claims 9 to 13, wherein the control system is further configured to monitor a presence of the anaesthetic agent in the accumulator.

15. The system of claim 14, wherein the control system is further configured to, in response to a volume of the anaesthetic agent in the accumulator being greater than a threshold volume, increase a flow rate of the anaesthetic agent out of the accumulator.

16. A method of collecting an anaesthetic agent from a collection vessel, the method comprising:
receiving a heated fluid at the collection vessel housing an adsorbent material, the anaesthetic agent being adsorbed to the adsorbent material, the heated fluid having a temperature and a pressure sufficient to thermally desorb the anaesthetic agent from the adsorbent material;
providing an outlet stream to a heat exchanger from the collection vessel, the outlet stream comprising a vapor comprising the anaesthetic agent;
cooling the outlet stream by the heat exchanger to a temperature below a threshold temperature to produce a liquid stream comprising the anaesthetic agent; and
separating the liquid stream into a waste stream and a collection stream by settling at an accumulator, the collection stream comprising the anaesthetic agent.

17. The method of claim 16, wherein the temperature of the heated fluid is in a range of about 90° C. to about 110° C.

18. The method of claim 16 or claim 17, wherein the pressure of the heated fluid is about 15 PSI.

19. The method of any one of claims 16 to 18, wherein the heated fluid is steam.

20. The method of any one of claims 16 to 19, wherein the collection vessel has a temperature of about in a range of about 90° C. to about 110° C.

21. The method of any one of claims 16 to 20, wherein the adsorbent material is activated carbon.

22. The method of claim 21, wherein the anaesthetic agent is a halogenated hydrocarbon.

23. The method of any one of claims 16 to 22, wherein the heat exchanger cools the outlet stream to a temperature of about 5° C. to produce the liquid stream.

24. The method of any one of claims 16 to 23 further comprising monitoring the temperature of the collection vessel by a control system.

25. The method of claim 24 further comprising, in response to the temperature of the collection vessel falling below a threshold pressure, increasing a flow rate of the heated fluid into the collection vessel.

26. The method of claim 24 further comprising, in response to the temperature of the collection vessel rising above a threshold pressure, decreasing a flow rate of the heated fluid into the collection vessel.

27. The method of any one of claims 24 to 26 further comprising monitoring a temperature of the liquid stream downstream from the heat exchanger by the control system.

28. The method of claim 24 further comprising, in response to the temperature of the liquid stream rising above a critical liquid temperature, controlling the heat exchanger to lower the temperature of the liquid stream.

29. The method of any one of claims 27 to 28 further comprising monitoring a presence of the anaesthetic agent in the accumulator.

30. The method of claim 29 further comprising, in response to a volume of the anaesthetic agent in the accumulator being greater than a threshold volume, increasing a flow rate of the anaesthetic agent out of the accumulator.

31. Any and all features of novelty and inventiveness described, referred to, shown as examples, or otherwise described herein.
